(19) United States
(12) Patent Application Publication
(10) Pub. No.: US 2018/0184685 A1
(43) Pub. Date: Jul. 5, 2018

(54) Protein Product and Process for Making Protein Product from Uncooked Meat Purge

(71) Applicant: Proteus Industries, Inc., Gloucester, MA (US)

(72) Inventors: Stephen D. Kelleher, Ipswich, MA (US); William R. Fielding, Hilton Head, SC (US)

(73) Assignee: Proteus Industries, Inc., Gloucester, MA (US)

(21) Appl. No.: 15/818,962

(22) Filed: Nov. 21, 2017

Related U.S. Application Data
(63) Continuation of application No. 13/385,397, filed on Feb. 21, 2012, now abandoned.
(60) Provisional application No. 61/517,920, filed on Apr. 28, 2011.

(51) Int. Cl. A23J 1/02

(52) U.S. Cl. CPC A23J 1/02

(57) ABSTRACT

A precipitated purge protein is obtained from animal muscle tissue purge. Animal muscle tissue purge is mixed with a food grade acid to form an aqueous acidic solution of animal muscle tissue purge. The acidic solution is mixed with a food grade base to precipitate the protein in the solution. The precipitated protein then is recovered.

### REFERENCE TO RELATED APPLICATION

This application is a continuation of U.S. application Ser. No. 13/385,397, entitled, “Protein product and process for making protein product from uncooked meat purge” by Stephen D. Kelleher et al., filed Feb. 21, 2012, which claims the benefit of the filing date of application Ser. No. 61/517,920, filed Apr. 28, 2011. The entire teachings of the above applications are incorporated herein by reference.

### BACKGROUND OF THE INVENTION

This invention relates to a novel protein composition derived from liquid exudate from uncooked animal muscle tissue and a process for making the protein composition.

At the present time, it is desirable to recover the maximum edible food from slaughtered animals for human consumption. During the slaughtering process wherein edible animal muscle tissue (meat) liquid exudate from the meat are separated from the animal muscle connective tissue. These exudates include an aqueous liquid containing solubilized proteins and are referred to in the art as “purge”. Purge presently is discarded and not used further. Since the purge includes proteins normally present in the meat, they are a potential source of nutritional food for human beings. Because these exudates are discarded, this practice comprises a significant economic loss for a meat producer.

Accordingly, it would be desirable to provide a solid protein rich product from uncooked meat purge and a process for making the solid protein product. Such a solid protein product would provide a rich source of nutritional protein for human consumption and being solid would be in a form which promotes ease of addition to solid foods by admixture therewith.

### SUMMARY OF THE INVENTION

In accordance with this invention, it has been found that a novel solid protein composition comprising predominantly sarcoplasmic proteins and minor amounts of myofibrillar proteins can be derived from the purge of uncooked animal muscle tissue. The purge is obtained when storing uncooked meat under sanitary storage conditions. The purge comprises the excess liquid, in the uncooked meat which drips from the meat during storage. In accordance with this invention, the purge is recovered and then mixed with a food grade acid composition under conditions to modify the protein in the purge thereby forming a solution of protein derived from animal muscle tissue protein having a pH less than about 3.8. The solubilized acidic proteins then are mixed with a food grade base composition to increase the pH of the solubilized proteins to a pH between about 4.7 and about 11.0, preferably between about pH 5.5 and about 9.5, thereby to precipitate the protein. The precipitated protein is then recovered. It has been found that when the solid protein and blood protein composition prepared by the process of this invention is useful as a food additive protein source for human consumption.

While applicants do not wish to be bound to any theory, it is believed that by first mixing the purge derived from animal muscle tissue with a food grade acid, unfolding of the protein molecules is promoted and the subsequent mixing of the resultant protein with a food grade alkaline compound promotes protein precipitation which results in increased yields of precipitated protein.

The purge feed useful in this invention can be derived from any form of animal muscle tissue including that obtained from poultry such as chicken, lamb, beef, pork or the like.

### DESCRIPTION OF SPECIFIC EMBODIMENTS

In accordance with this invention, in a first step, the liquid purge recovered from uncooked meat is mixed with a food grade acid composition under conditions to modify protein in the purge. The resultant acidic purge protein solution has a pH of about 3.8 or less, but not so low as to adversely affect the protein functionality, and preferably between about 2.0 and about 3.8, most preferably between about 2.5 and about 3.8.

Any food grade or pharmaceutically acceptable acid that does not undesirably contaminate the acidic protein product can be used to lower the pH of the purge. For example, organic acids (e.g., citric acid, ascorbic acid, malic acid or tartaric acid) or mineral acids (e.g., hydrochloric acid, phosphoric acid, sulfuric acid) or mixtures thereof or the like. Acids that have significant volatility and impart undesirable odors, such as acetic acid or butyric acid, are undesirable. The purge is mixed with sufficient acid to form a solution having a pH of 3.8 or less, but not such a low pH as to adversely modify the purge protein. The protein composition formed is free of myofibrils and sarcomeres.

The acidic protein solution then is mixed with a food grade or pharmaceutically acceptable alkaline composition to raise the pH of the acidic protein solution to a pH of between about 4.7 and about 11.0, preferably between about 5.5 and about 9.5 to precipitate the purge protein. Representative suitable alkaline compositions include sodium hydroxide, potassium hydroxide, sodium bicarbonate, potassium bicarbonate or mixtures thereof or the like. The precipitated animal muscle protein then is recovered such as by filtration or centrifugation.

The protein products utilized in the present invention comprise primarily sarcoplasmic proteins that also contain small amounts of myofibrillar proteins. This was also found previously for fresh pork exudates. Meat Science 53:145-148. The sarcoplasmic proteins in the protein product comprises about 50%, preferably above about 75%, more preferably above about 85% by weight sarcoplasmic proteins, based on the total weight of the protein.

In one aspect of this invention, uncooked particulate meat or fish such as ground meat or fish, e.g., hamburger, is mixed with or injected with or coated with precipitated protein in order to retain moisture in the meat or fish during cooking. The precipitated protein is added to effect a weight ratio usually comprising about 0.03 to about 18% weight protein based on the weight of the uncooked meat or fish, preferably between about 0.5 and 10% weight protein based on the weight of uncooked meat or fish and most preferably comprising about 0.5 to about 5% weight protein based on the weight of the uncooked meat or fish. When utilizing less than about 0.3% weight of the precipitated protein of this invention, effective moisture retention after cooking is not observed. The precipitated protein can be comminuted prior to mixing with the meat or fish.

The animal muscle tissue which is modified to retain moisture in accordance with this invention comprises meat and fish, including shell fish. Representative suitable fish include deboned flounder, sole, haddock, cod, sea bass, salmon, tuna, trout or the like. Representative suitable shell fish include shrimp, crabmeat, crayfish, lobster, scallops, oysters, or shrimp in the shell or the like. Representative suitable meats include ham, beef, lamb, pork, venison, veal, buffalo or the like; poultry such as chicken, mechanically deboned poultry meat, turkey, duck, goose or the like either in fillet form or in ground form such as hamburg. The meats can include the bone of the animal when the bone does not adversely affect the edibility of the meat such as spare ribs, lamb chops or pork chops. In addition, processed meat products which include animal muscle tissue such as a sausage composition, a hot dog composition, emulsified product or the like can be injected or mixed with the protein suspension of this invention or a combination of these protein addition methods. Sausage and hot dog compositions include ground meat or fish, herbs such as sage, spices, sugar, pepper, salt and fillers such as dairy products as is well known in the art.

The fish or meat containing the precipitated protein suspension of this invention then can be cooked in a conventional manner such as by baking, broiling, deep fat frying, in a microwave oven or the like. It has been found that the cooked meat or fish provided in accordance with this invention weighs between about 1 and about 20%, more usually between about 4% and about 9% by weight greater than cooked untreated meat or fish starting from the same uncooked weight. In addition, when frozen meat or fish containing the protein suspension is that drip loss from the food is reduced between about 4 and about 15% as compared with meat or fish not containing the precipitated protein of this invention.

The following examples illustrate the present invention and are not intended to limit the same.

### Example I

Purge was collected from the bottom of stainless steel containers that held refrigerated bulk beef rounds. The temperature was kept 43° F.±14° F. Hydrochloric acid (HCl-2N) was added to the purge until a pH of 2.8 was obtained. Aliquots of the acidified mixture were subsequently adjusted to pH values between 5.5-6.5 to effect precipitation of the proteins. The precipitates were filtered through wire mesh and gently pressed by hand to obtain a final product of beef proteins. In a test to determine yield ingoing purge was compared to precipitated protein and the results were a recovery yield of 44% by weight.

### Example II

Sliced beef round in vacuum poly packaging was purchased at the local supermarket in fresh state. Product was placed into a stainless steel bowl and allowed to set overnight in a refrigerator with a light weighted object to enhance exudates loss. Purge was recovered and frozen and analyzed for proximate analysis with results shown in Tables 1 and 2.

TABLE 1
Proximate Analysis of beef purge.

| | |
|---|---|
| Protein | 11.1% |
| Fat | 0.8% |
| Moisture | 87.2% |
| Ash | 1.2% |
| Carbohydrate | <0.1% |

TABLE 2
Amino acid profile of beef and beef purge

| | | Amino acids |
|---|---|---|
| | Protein from beef | from Beef Purge |
| | (% of total protein) | (% of total protein) |
| Aspartic acid | 10.65 | 9.11 |
| Threonine* | 4.39 | 3.97 |
| Serine | 5.59 | 3.97 |
| Glutamic acid | 16.25 | 12.00 |
| Glycine | 7.72 | 4.82 |
| Alanine | 6.72 | 6.00 |
| Valine* | 4.46 | 6.00 |
| Methionine* | 2.86 | 2.25 |
| Isoleucine* | 3.79 | 4.93 |
| Leucine* | 8.39 | 8.36 |
| Tyrosine | 3.20 | 3.32 |
| Phenylalanine* | 4.73 | 4.18 |
| Lysine* | 10.79 | 9.97 |
| Histidine* | 3.40 | 7.07 |
| Arginine | 7.06 | 5.36 |
| Proline | NA | 5.89 |
| Hydroxyproline | NA | 0.11 |
| Cystine | NA | 1.50 |
| Tryptophan | NA | 1.18 |
| *Essential amino acids (%) | 42.81 | 46.73 |

1) A protein rich purge composition comprising predominately sarcoplasmic proteins derived from purge of uncooked meat, said protein rich purge composition obtained by a process comprising the steps of:
a) recovering a quantity of purge that is a liquid exudate from uncooked animal muscle tissue that contains predominately sarcoplasmic proteins,
b) mixing said recovered purge with a food grade acid composition to form an aqueous acidic solution of purge protein having a pH below about 3.5.
c) mixing said aqueous acidic solution of purge protein with a food grade alkaline composition to form an aqueous composition of purge protein having a pH between about 4.7 and about 11.0 in which said sarcoplasmic proteins are precipitated; and
d) recovering said sarcoplasmic precipitated proteins as said protein rich purge composition, wherein sarcoplasmic precipitated proteins are present in an amount of at least 50% by weight of total protein;
wherein steps a) through d) are performed without the addition of other animal muscle tissue.

2) The composition of claim 1 wherein the purge is beef purge.

3) The composition of claim 1 wherein the purge is pork purge.

4) The composition of claim 1 wherein the purge is lamb purge.

5) The composition of claim 1 wherein the purge is chicken purge.

6) The composition of claim 1, wherein the pH of the aqueous acidic solution is between about 2.5 and about 3.5.

7) The composition of claim 1, wherein the pH of the precipitated protein is between about 5.5 and about 9.5.

8) The process for forming a protein rich purge composition from a purge, said process including the steps of:
a) recovering a quantity of purge that is a liquid exudate from uncooked animal muscle tissue, wherein the purge contains predominately sarcoplasmic proteins,
b) mixing the recovered purge with a food grade acid composition to form an aqueous acidic solution of purge protein having a pH between about 2.0 and about 3.5.
c) mixing said aqueous acidic solution of purge protein with a food grade alkaline composition to form an aqueous composition of purge protein having a pH between about 4.7 and about 11.0 in which the sarcoplasmic proteins are precipitated; and
d) recovering said sarcoplasmic precipitated proteins as the protein rich purge composition, wherein sarcoplasmic precipitated proteins are present in an amount of at least 50% by weight of total protein;
wherein steps a) through d) are performed without the addition of other animal muscle tissue.

9) The process of claim 8 wherein the purge is beef purge.

10) The process of claim 8 wherein the purge is pork purge.

11) The process of claim 8 wherein the purge is lamb purge.

12) The process of claim 8 wherein the purge is chicken purge.

13) The process of claim 8, wherein the pH of the aqueous acidic solution is between about 2.5 and about 3.5.

14) The process of claim 8, wherein the pH of the precipitated protein is between about 5.5 and about 9.5.
